(19) United States
(12) Patent Application Publication
(10) Pub. No.: US 2007/0227903 A1
(43) Pub. Date: Oct. 4, 2007

(54) Precious Metal Recovery

(76) Inventors: Andrew Derek Turner, Oxfordshire (GB); Francisco Javier Del Campo, Barcelona (ES); Malcolm Robert Adam, Oxfordshire (GB)

Correspondence Address: LAW OFFICES OF WILLIAM H. HOLT, 12311 HARBOR DRIVE, WOODBRIDGE, VA, 22192, US

(21) Appl. No.: 11/578,109

(22) PCT Filed: Apr. 4, 2005
(86) PCT No.: PCT/GB05/01294

§ 371 Date: Nov. 17, 2006

(30) Foreign Application Priority Data
Apr. 8, 2004 (GB) 0408805.0

(51) Int. Cl. B23H 3/00

(52) U.S. Cl. 205/705

(57) ABSTRACT

Precious metals can be selectively removed from a solution containing an excess of base metals by electrolysis in a divided cell. This necessitates controlling the pH of the solution, and controlling the voltage applied to the electrodes, such that precious metals are deposited preferentially on the electrode in contact with the solution. For example the precious metals may be deposited selectively onto an anode, presumably with formation of a hydrous oxide, if the pH is held at say less than pH 1.0 and the cell voltage held less than 1.3 V.

This invention relates to a method and an apparatus for the recovery of precious metals from a solution in which there is an excess of base metal, for example in a metal recycling process.

In this context the term precious metal refers to metals such as platinum and palladium, and similar metals such as iridium and rhenium. Gold may also be considered a precious metal, whereas silver may be considered as only semi-precious. Base metals refer to metals such as copper and nickel.

According to the present invention there is provided a method for selectively removing precious metals from a solution containing an excess of base metal, the method comprising subjecting the solution to electrolysis in a cell comprising a first electrode and a second electrode separated by an ion-selective membrane, and the method comprising controlling the pH of the solution, passing the solution adjacent to the first electrode, and ensuring the voltage applied to the electrodes remains sufficiently low that precious metals are deposited preferentially on the first electrode while base metals remain in solution.

The deposition may be at the anode, and this may involve formation of a hydrous oxide. The anode may be of a conducting oxide such as iridium oxide/niobium oxide (IrO₂/Nb₂O₅), or titanium oxide (Ti₄O₇), or possibly carbon.

The pH of the solution may be raised by addition of a base such as sodium hydroxide or ammonium hydroxide, or even by adding water, but preferably by removal of acid by an electrodialytic process. For example the solution may be subjected to electrodialysis between monovalent cation-selective and anion-selective membranes. If it were necessary to reduce the pH, this could be achieved by addition of acid, but more preferably by removal of base via an analogous electrodialytic process, using a monovalent cation-selective membrane and a bipolar membrane.

Alternatively the deposition may be at the cathode, with deposition of the metal itself. Preferably the deposit is subsequently redissolved electrolytically, for example the precious metal deposited on the cathode may be dissolved by subsequently making the electrode an anode in an acidic solution of hydrogen chloride.

In principle the electrochemical cell may have any one of a number of different geometries, for example cylindrical, parallel plate, rotating electrode, packed bed, or fluidised bed. However to ensure accurate potential control a relatively narrow gap between the electrodes is needed, with parallel geometry. Packed beds and fluidised beds are therefore less likely to be suitable. The ion-selective membrane would suppress any redox shuttles (such as Cu⁺/Cu⁺⁺). The membrane is preferably oxidation resistant.

It will be appreciated that the electrochemical techniques described above may be combined with other conventional separation methods, including precipitation and solid/liquid separation, solvent extraction, or ion exchange. Such processes may be used as a pre-treatment, to remove much of the base metal content of the solution, so that the solution can then be treated as described above to remove the precious metals with less competition from base metal ions. For example, the addition of phosphate ions to a pH of about 3.45 results in most of the base metal ions precipitating as insoluble phosphates. To enhance the crystallisation process this may be performed at an elevated temperature, and also subjected to ultrasonic irradiation; larger crystals are easier to separate from the resulting liquid. The liquid phase may then be treated as described above. Alternatively, solvent extraction may be used to selectively remove base metals such as copper and nickel, leaving the precious metals in the aqueous solution; the aqueous solution may then be treated as described above. Alternatively chelating resins may be used to remove copper and nickel ions selectively, the resulting aqueous solution then being treated as described above. The method of the invention is applicable even with very low concentration of precious metals, for example as low as 100 ppm, and the base metal may be considerably more concentrated, for example 10 to 100 times more.

The invention also provides an apparatus for performing such a process.

The invention will now be further and more particularly described by way of example only, and with reference to the accompanying drawings in which:

FIG. 1 shows a diagrammatic view of apparatus for precious metal recovery, incorporating an electrodialysis cell and an electrodeposition cell;

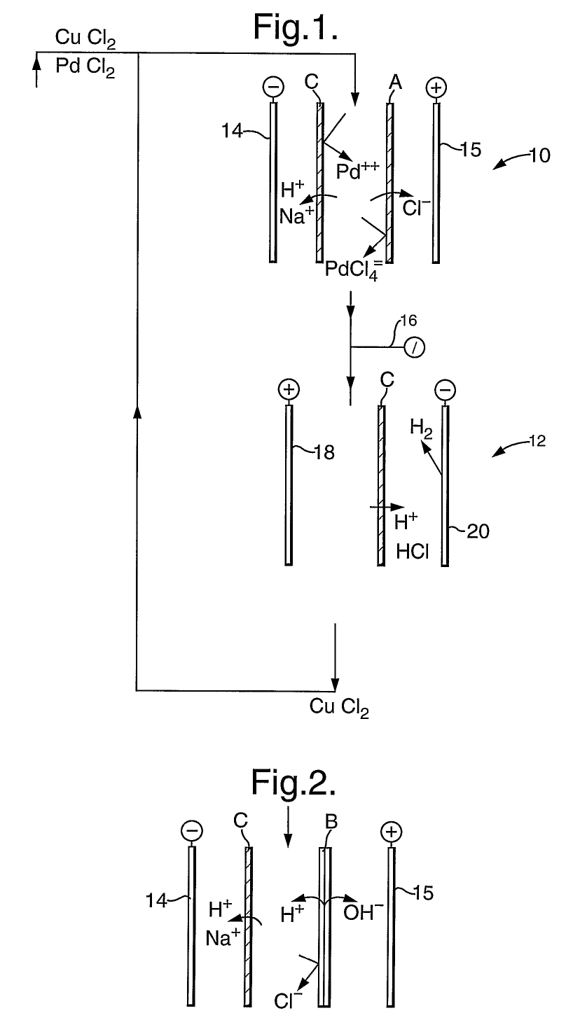

FIG. 2 shows a modified electrodialysis cell for use in the apparatus of FIG. 1;

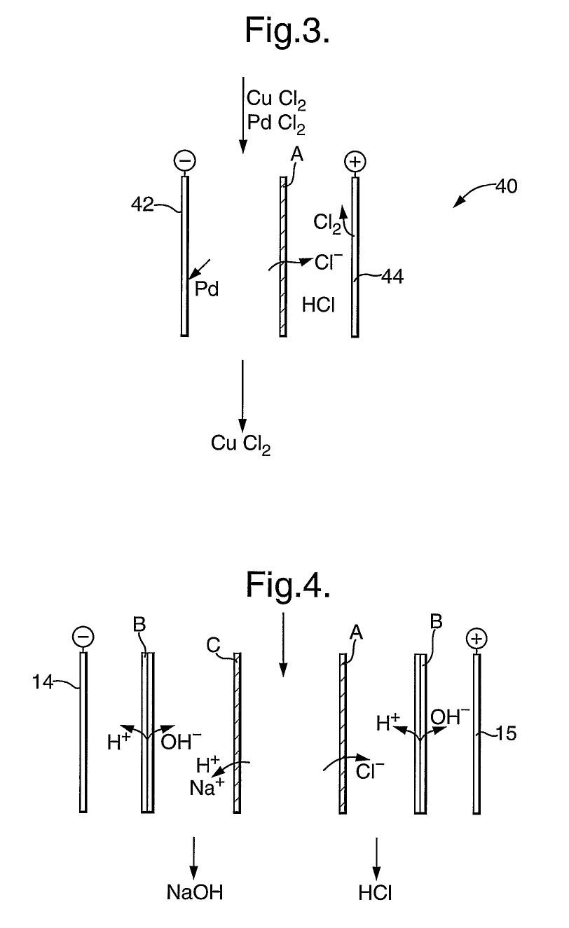

FIG. 3 shows a modified electrodeposition cell for use in the apparatus of FIG. 1; and

FIG. 4 shows another modified electrodialysis cell for use in the apparatus of FIG. 1.

In this example a solution initially contains iridium, platinum, palladium and ruthenium as chlorides at low concentrations, and a much higher concentration of copper chloride, and the solution is acidic. At least some of the precious metals may be in the form of chloro-complexes. The solution is recirculated through two successive cells 10 and 12. The first cell 10 is an electrodialytic cell in which the solution is passed between monovalent cation and monovalent anion-selective membranes (marked C and A) between a cathode 14 and an anode 15. Cations of the metals are not monovalent, and chloro-complexes of the precious metals are also not monovalent, so they are not affected, so that the overall result is that chloride ions are removed (through the anion membrane A) and cations such as hydrogen and sodium are removed (through the cation membrane C), so that the pH gradually increases. The pH is raised to about pH 4 by controlling the current supplied to the cell 10, and the pH is monitored by a pH sensor electrode 16. It will be appreciated that it is desirable to keep the pH below pH 5, or copper hydroxide would tend to precipitate.

The second cell 12 is a separated cell, with a monovalent cation-selective membrane C separating the region around the anode 18 (to which the solution is supplied) from the region around the cathode 20 (where there is an aqueous solution of hydrogen chloride). The cathode 20 is of platinum-coated titanium, so that hydrogen is evolved at the cathode; the voltage of the cathode 20 may therefore be taken as being close to that of a standard hydrogen electrode. The potential difference between the electrodes of the cell 12 is carefully controlled to low values so that the desired metal or metals are deposited at the anode 18; this deposition may be assumed to be an oxide.

Referring out to Table 1, this shows the standard electrode potentials E₀ for various couples involving precious metals, and also the corresponding values for some couples involving base metals, and for chlorine; for deposition of oxides the electrode potentials vary linearly with the pH.

TABLE 1

| PGMs | | | Base metals | |
|---|---|---|---|---|
| Metal couple | E_{o/V} | | Metal couple | E_{o/V} |
| RuO₄/RuO₂ | 1.387-0.0591 | pH | Cu | none |
| RhO₂/Rh³⁺ | 1.881-0.2364 | pH | Ni₃O₄/Ni²⁺ | 1.977-0.2764 pH |
| Rh₂O₃/Rh²⁺ | 1.349-0.1773 | pH | Ni₂O₃/Ni²⁺ | 1.753-0.1753 pH |
| RhO₂/RhCl₆³⁻ | >1.4-0.2364 | pH | NiO₂/Ni²⁺ | 1.593-0.1182 pH |
| IrO₂/Ir³⁺ | 0.233-0.2364 | pH | AgO/Ag⁺ | 1.772-0.1182 pH |
| PtO₂/Pt²⁺ | 0.837-0.1182 | pH | Ag₂O₃/Ag⁺ | 1.670-0.0886 pH |
| PdO₂/Pd²⁺ | 1.194-0.1182 | pH | Zn | none |
| AuO₂/Au³⁺ | 2.507-0.2364 | pH | Pb₃O₄/Pb²⁺ | 2.094-0.2364 pH |

| | |
|---|---|
| PbO₂/Pb²⁺ | 1.449-0.1182 pH |
| Cl₂/Cl⁻ | 1.359 |

In this example the cathode 20 has a voltage very close to that of standard hydrogen electrode, and consequently the voltage across the cell 12 is a direct measure of the voltage between the anode 18 and the adjacent solution (after making allowance for the electrical resistance across the two electrolytes and the membrane C; this emphasizes the desirability of a relatively narrow gap and parallel electrodes, a large area and a small current density to minimise this voltage loss) . If the voltage between the anode 18 and the adjacent solution exceeds the value E₀ in the Table, then the corresponding deposition can be expected to occur. Hence in this case deposition of copper at the anode is not expected, and evolution of chlorine gas will occur if the voltage exceeds 1.359 V, so the cell voltage must generally be kept below that value.

The anode 18 must be of a material that will not undergo electrolysis itself, to form cations, under these conditions. It may be of a conducting oxide such as iridium oxide/niobium oxide (IrO₂/Nb₂O₅), or titanium oxide (Ti₄O₇), or of carbon; such materials may be used in solid form, or as a polymer-bound composite for example using PTFE or PVdF as the binder. It is also desirable for the resistance of the electrode itself to be small, so that the electrode preferably includes a metal substrate of a good electrical conductor. For example the substrate may be of titanium, connected to a copper current feeder.

Initially the cell voltage may be held at a voltage above 0.25 V, say 0.5 V. At this potential iridium is deposited at the anode (presumably as an oxide). The anode 18 can then be replaced by another anode, and the cell voltage raised to 0.8 V; the solution is then recirculated again, and at this anode voltage platinum is deposited at the anode 18 (presumably as oxide). (Instead of replacing the anode 18, the solution may be transferred to another cell 12, with a different cell voltage.) The anode 18 can then be replaced again, and the cell voltage raised to 1.2 or 1.3 V, leading to deposition of palladium (presumably as oxide). Finally the anode 18 may be replaced again, and the cell voltage raised to about 1.4 V, leading to evolution of chlorine gas and also ruthenium tetroxide; the latter remains in solution, and the solution is preferably then subjected to a gas purge (with say air) to evaporate the ruthenium tetroxide, the vapour then being scrubbed using a solution of a reducing agent such as sodium nitrite or sugar, to form ruthenium dioxide which is a precipitate.

The electrodes 18 on which iridium, platinum and palladium have been deposited can then be treated, for example in a separate cell (not shown) or indeed in the same cell, with dilute acid as electrolyte, making the electrode 18 less anodic so that the deposit redissolves to form a concentrated solution of the precious metal.

By operating at say pH 4, the anodic deposition voltages for oxide deposition are decreased, as compared to operating at more acidic conditions (e.g. pH 0), because of the pH dependence of E₀. Hence it is also possible to obtain deposition of rhodium at cell voltages below those for chlorine evolution.

It will be appreciated that the cell 12 may be operated in a different fashion to that described above. In particular the cell might only be operated at 1.2 or 1.3 V, so that iridium, platinum and palladium are all deposited together. It will also be appreciated that the exact mode of operation will depend upon the precious metals and base metals that are present in the solution. For example if nickel, silver or lead is present then the pH is desirably held at about pH 1 (or less). This may be achieved using an electrodialysis cell 30 as shown in FIG. 2, to which reference is now made, differing from the cell 10 only in using a bipolar membrane B in place of the anion-selective membrane A. Operation of this cell 30 leads to a reduction in the concentration of sodium ions but no reduction in chloride ions, and a smaller increase in hydrogen ions; hence the pH is decreased. At a pH below pH 1, nickel, silver and lead will not deposit at the anode 18, whereas the precious metals will deposit as described earlier.

In a further modification the cathode 20 of the deposition cell 12 need not be a hydrogen-evolving electrode. For example the catholyte might be a solution of say a nickel salt, for which at a cathode the equilibrium Ni⁺⁺/Ni occurs at E₀=−0.25 V. The appropriate cell voltages for deposition of the precious metals at the anode 18 are therefore increased by 0.25 V compared to the figures quoted above.

In an alternative, referring now to FIG. 3 which shows an alternative electrode deposition cell 40, the precious metals may instead be deposited as a metal onto a cathode. In this case the cell 40 is divided by a monovalent anion-selective membrane A, and the solution to be treated is supplied as catholyte to the vicinity of the cathode 42. The anode 44 is of a material such as conductive titanium oxide (as in the cell 12), and the anolyte is hydrochloric acid. The electrical conditions at which metals are deposited at the cathode can again be summarized by the corresponding standard electrode potentials E₀ (relative to a standard hydrogen electrode), as shown in Table 2.

TABLE 2

| | |
|---|---|
| PGMs | Base metals |

| Metal couple | E_{o/V} | Metal couple | E_{o/V} |
|---|---|---|---|
| Ru₂O₃/Ru | 0.738-0.0591 pH | Cu²⁺/Cu | 0.0337 |
| RuCl₅⁼/Ru | 0.4 | Ni²⁺/Ni | −0.25 |
| RuCl₅OH⁼/Ru | 0.6 | Ag⁺/Ag | 0.799 |
| Rh³⁺/Rh | 0.799 | Zn²⁺/Zn | −0.763 |
| Ir³⁺/Ir | 1.156 | Pb₂₊/Pb | −0.126 |
| IrCl₆³⁻/Ir | 0.835 | Cu²⁺/CuCl | 0.538 |
| Pt²⁺/Pt | 1.188 | CuCl/Cu | 0.137 |
| PtCl₄²⁻/Pt | 0.73 | AgCl/Ag | 0.222 |
| Pd²⁺/Pd | 0.987 | | |
| PdCl₄²⁻/Pd | 0.62 | | |
| Au³⁺/Au | 1.498 | | |

Deposition of the metals at the cathode 42 will occur if the voltage of the cathode relative to the catholyte is less than the values given in the table. At the anode 44 chlorine gas is evolved, so the anode 44 is at about 1.4 V (relative to a standard hydrogen electrode; see table 1); if the cathode is at say 1.2 V or 1.3 V (relative to a standard hydrogen electrode) from the table it is apparent that gold, if present, will be deposited, but that copper will not. Hence if the voltage across the cell 40 is held at say 0.2 V (excluding resistive voltage drop), then gold is selectively deposited. The cell voltage could then be held at 0.45 V, corresponding to a cathode voltage of 0.95 V (relative to a standard hydrogen electrode), at which iridium and platinum will be deposited selectively despite the high concentration of copper in the solution. At a cell voltage of 0.8 V (excluding resistive voltage drop), corresponding to a cathode voltage of 0.6 V, rhodium, iridium and platinum would all be deposited from a chloride-rich medium despite the high copper concentration, with minimal reduction of Cu(II) to Cu(I) At a still lower cathode potential of 0.25 V (i.e. cell voltage 1.15 V excluding resistive drop), palladium and ruthenium can be deposited; the current efficiency is reduced due to reduction of Cu (II) to Cu(I) chloro-complexes, but the cost of the electricity is insignificant in comparison to the value of the deposited metals.

It will be appreciated that if the metal stream instead contains base metals such as zinc, lead or nickel, these deposit at significantly more cathodic potentials, so the cell voltage can easily be arranged to ensure that the precious metals are deposited preferentially. On the other hand, if silver is present. as a chloro-complex, its deposition voltage is only about 0.2 V, so it too can be separated from the precious metals.

It will be appreciated that instead of treating a batch of liquid by a recirculation process as described in relation to FIG. 1, instead the solution might be passed through a several cells 12 or 40 in succession, as a continuous process. Such a continuous process may utilise either anodic or cathodic deposition.

It will also be appreciated that the electrodialytic pH control cell may be arranged to provide acid and basic output streams that may be recycled for use. For example the cell 10 of FIG. 1 may be replaced by the electrodialytic cell 50 of FIG. 4. This differs from the cell 10 only in that the membranes C and A (between which the feed solution flows) are separated from the cathode 14 and anode 15 by bipolar membranes B. Hence sodium hydroxide solution is generated behind the cation-selective membrane C, and hydrochloric acid solution is generated behind the anion-selective membrane A. As described before, the pH of the feed solution is thereby raised.

In each metal-deposition cell 12 or 40, the precious metal undergoes deposition at one electrode, and a membrane separates the liquid being treated from the electrode of opposite polarity. As a rule, there are several different options for this membrane. Where deposition occurs at an anode, the membrane may be bipolar (in which case there is no ion transport through the membrane, but water splitting within it, and the cell voltage would need to be increased by 0.84 V to allow for this) , or the membrane may be monovalent cation selective (as in cell 12 of FIG. 1), or the membrane may be anion selective (so allowing chloride ions to transfer from the catholyte). Where deposition is at a cathode, the membrane may be bipolar (so needing an extra 0.84 V), or monovalent anion selective (as in cell 40 of FIG. 3) or cation selective (so allowing hydrogen ions to transfer from the anolyte).

1. A method for selectively removing precious metals from a solution containing an excess of base metal, the method comprising the steps of subjecting the solution to electrolysis in a cell comprising a first electrode and a second electrode separated by an ion-selective membrane, controlling the pH of the solution, passing the solution adjacent to the first electrode, the first electrode being the anode of the cell, and ensuring the voltage applied to the electrodes of the cell remains sufficiently low and the voltage between the first electrode and the solution is such that precious metals are deposited by electrolysis preferentially on the first electrode, forming oxides, while base metals remain in solution.

2. (canceled)

3. A method as claimed in claim 1 wherein the anode comprises a conducting oxide such as iridium oxide/niobium oxide (IrO₂/Nb₂O₅), or titanium oxide (Ti₄O₇).

4. A method as claimed in claim 1 wherein the pH of the solution is controlled by an electrodialytic process.

5. A method as claimed in claim 1 wherein the oxide deposit is subsequently redissolved electrolytically.

6. A method as claimed in claim 1 wherein a plurality of different precious metals are removed and deposited as oxides sequentially, by subjecting said solution to a sequence of electrolysis steps at different voltages.

7. A method as claimed in claim 1 wherein during the deposition process said solution is held below pH 5.

8. A method as claimed in claim 5 wherein the electrolyte into which the oxide deposit is redissolved is a dilute acid.

9. A method as claimed in claim 1 also comprising a step of selectively removing precious metals from said solution containing an excess of base metal, by subjecting said solution to electrolysis in a second cell comprising a first electrode and a second electrode separated by an ion-selective membrane, controlling the pH of said solution, and passing said solution adjacent to the first electrode, the first electrode being the cathode of the second cell, and ensuring the voltage applied to the electrodes of the second cell remains sufficiently low and the voltage between the first electrode and the solution in the second cell is such that precious metals are deposited by electrolysis preferentially on the first electrode, while base metals remain in solution.
